(19) United States
(12) Patent Application Publication
(10) Pub. No.: US 2009/0150530 A1
(43) Pub. Date: Jun. 11, 2009

(54) Server device, terminal device, content sender/receiver system, content sender/receiver method, and program

(75) Inventor: Masahiro Shohda, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/315,101

(22) Filed: Nov. 25, 2008

(30) Foreign Application Priority Data
Dec. 5, 2007 (JP) P2007-314881

(51) Int. Cl. G06F 15/177

(52) U.S. Cl. 709/222

(57) ABSTRACT

A server device configured to send a content to a terminal device when the server device and the terminal device are capable of connecting to each other, the server device includes a selected metadata receiver section configured to, when metadata concerning the content that is not stored in the terminal device has been selected in the terminal device, receive the selected metadata, and a content sender section configured to send the content related to the selected metadata to the terminal device.

### CROSS REFERENCES TO RELATED APPLICATIONS

The present invention contains subject matter related to Japanese Patent Application JP 2007-314881, filed in the Japanese Patent Office on Dec. 5, 2007, the entire contents of which being incorporated herein by reference.

### BACKGROUND OF THE INVENTION

1. Field of the Invention

The present invention relates to a server device, a terminal device, a content sender/receiver system, a content sender/receiver method, and a program.

2. Description of the Related Art

A portable recording/reproducing device (which is an example of a terminal device, and will be hereinafter referred to as a “portable device” as appropriate) contains a recording medium, but the storage capacity of the recording medium therein is generally small compared to that of a stationary computer or recording/reproducing device (which is an example of a server device, and will be hereinafter referred to as a “host device” as appropriate) or the like. Some portable recording/reproducing devices do not have a communication capability that allows the portable recording/reproducing devices to be connected to the Internet or the like. Accordingly, some portable recording/reproducing devices are connected to an external computer or recording/reproducing device that contains a recording medium with a larger storage capacity and which is capable of being connected to a network such as the Internet. This allows data to be added to the portable recording/reproducing devices via the external computer or recording/reproducing device.

For example, Japanese Patent Laid-Open Nos. 2006-197512, 2003-348508, and 2002-291066 disclose techniques related to the portable recording/reproducing devices that are capable of being connected to external devices, and describe data that are exchanged between the portable recording/reproducing devices and the external devices.

### SUMMARY OF THE INVENTION

The storage capacity of the portable recording/reproducing devices is limited, and in the case of the portable recording/reproducing devices that do not have the capability to connect to the network, the following approach is generally adopted. That is, content data are stored in an external device containing a recording medium with a larger storage capacity, and while the portable recording/reproducing device is connected to the external device, a user performs an operation of specifying content data that is to be transferred from the external device and recorded onto the portable recording/reproducing device.

While the portable recording/reproducing device is not connected to the external device, such as when carried by the user who is out of his or her home, the user is unable to recognize contents that can be Added to the portable recording/reproducing device through the external device or the external network. Therefore, if the user desires to add a new content to the portable recording/reproducing device, he or she needs to connect the portable recording/reproducing device to the external device to specify the content which he or she desires to add to the portable recording/reproducing device.

As such, the present embodiment addresses the above-identified, and other problems associated with existing methods and apparatuses, and provides a server device, a terminal device, a content sender/receiver system, a content sender/receiver method, and a program which allow the user, using the terminal device which is not connected to the server device, to specify in advance a content which he or she desires to transfer from the server device to the terminal device, and then, upon connection of the terminal device to the server device, to transfer the specified content from the server device to the terminal device quickly and easily.

According to one embodiment of the present invention, there is provided a server device for sending a content to a terminal device when the server device and the terminal device are capable of connecting to each other, the server device including: a selected metadata receiver section configured to, when metadata concerning the content that is not stored in the terminal device has been selected in the terminal device, receive the selected metadata; and a content sender section configured to send the content related to the selected metadata to the terminal device.

According to another embodiment of the present invention, there is provided a terminal device for receiving a content from a server device when the terminal device and the server device are capable of connecting to each other, the terminal device including: a recording section configured to record the content and metadata concerning the content on a storage medium; a selection section configured to select the metadata concerning the content that is not stored in the storage medium; a selected metadata sender section configured to send the selected metadata to the server device; and a content receiver section configured to receive the content related to the selected metadata from the server device.

According to yet another embodiment of the present invention, there is provided a content sender/receiver system for sending and receiving a content when a server device and a terminal device are capable of connecting to each other. The terminal device includes: a recording section configured to record the content and metadata concerning the content on a storage medium; a selection section configured to select the metadata concerning the content that is not stored in the storage medium; and a selected metadata sender section configured to send the selected metadata to the server device. The server device includes: a selected metadata receiver section configured to receive the selected metadata; and a content sender section configured to send the content related to the selected metadata to the terminal device. The terminal device further includes a content receiver section configured to receive the content related to the selected metadata from the server device.

According to the present embodiment, a user of the terminal device is able to specify a content which he or she desires to transfer from the server device to the terminal device in advance when the terminal device is not connected to the server device, so that the specified content will be transferred from the server device to the terminal device quickly and easily when the terminal device is connected to the server device next time.

### BRIEF DESCRIPTION OF THE DRAWINGS

FIG. 1 is a block diagram illustrating a content sender/receiver system according to a first embodiment of the present invention;

FIG. 2 is a flowchart illustrating an operation of the content sender/receiver system according to the first embodiment;

FIG. 3 is a schematic diagram illustrating the operation of the content sender/receiver system according to the first embodiment;

FIG. 4 is a diagram illustrating a display screen of a portable device according to the first embodiment;

FIG. 5 is a flowchart illustrating an operation of a content sender/receiver system according to a second embodiment of the present invention; and

FIG. 6 is a schematic diagram illustrating the operation of the content sender/receiver system according to the second embodiment.

### DETAILED DESCRIPTION OF THE PREFERRED EMBODIMENTS

Hereinafter, preferred embodiments of the present invention will be described in detail with reference to the accompanying drawings. Note that, in this specification and the accompanying drawings, like elements having substantially the same functions are assigned like reference symbols, and that redundant description will be avoided.

### First Embodiment

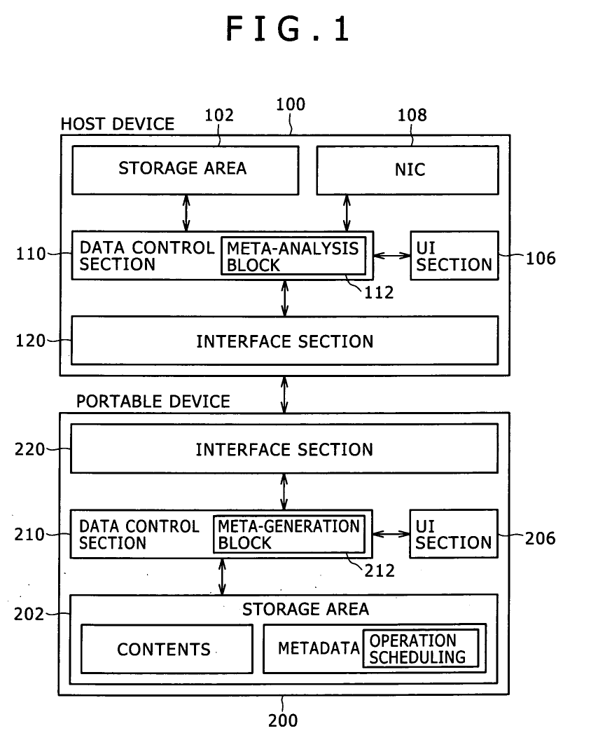

First, a content sender/receiver system according to a first embodiment of the present invention will now be described below. FIG. 1 is a block diagram illustrating the content sender/receiver system according to the present embodiment.

The content sender/receiver system according to the present embodiment includes a host device 100, in which contents are stored beforehand, and a portable device 200, which is a recording/reproducing device. Music, movie, or other contents are stored in the host device 100, for example. The portable device 200 is capable of being connected to the host device 100, and is also capable of receiving the content from the host device 100 and recording and reproducing the content.

First, the host device 100 according to the present embodiment will now be described below. As shown in FIG. 1, the host device 100 includes a storage area 102, a UI section 106, an NIC 108, a data control section 110, a meta-analysis block 112, and an interface section 120.

The storage area 102 is formed by an HDD or the like, for example. Under control of the data control section 110, the storage area 102 is capable of data writing, data reading, data deletion, and so on. Data related to music, movie, or other contents are stored in the storage area 102. The data of these contents may be data that has been read from an external storage medium (e.g., a CD) and written to the storage area 102. In addition, metadata concerning the content is stored temporarily in the storage area 102. The metadata includes: information for identifying the content (a title, an artist, and so on); a physical location at which the content is stored (e.g., a specific location (address) in the storage area 102, an external recording/reproducing device, etc.); information concerning data operation scheduling (for, for example, moving or copying of the content from the host device 100 to the portable device 200, purchasing the content from the network, deleting the content from the host device 100, and so on); the size of the content (which is referred to when determining whether the operation scheduling is possible); and DRM information (which is referred to when determining whether the operation scheduling is possible).

The term “data operation scheduling” as used herein refers to scheduling addition of a new content, deletion of a content, or the like (i.e., scheduling such an operation) using the portable device 200 in advance while the portable device 200 is not connected to the host device 100, so that the scheduled operation will be performed when the portable device 200 is connected to the host device 100.

The UI section 106 functions as a user interface to accept the operation by a user of the host device 100 and send data concerning the operation to the data control section 110. For example, the UI section 106 transfers the content from the external storage medium, and manages the contents stored in the storage area 102. In addition, the UI section 106 displays an operation being performed in the host device 100, so that the user can recognize the operation being performed in the host device 100. The NIC 108 is connected to the network such as the Internet to receive the content, for example.

The data control section 110 controls exchange of data such as the contents and the metadata with the portable device 200, generation and deletion of the data, the storage of the data in the storage area 102, and so on. The data control section 110 is an example of a metadata sender block, and, for example, sends the metadata generated in the host device 100 to the portable device 200.

The data control section 110 includes the meta-analysis block 112. The meta-analysis block 112 acquires the metadata received from the portable device 200, and analyzes the metadata. The meta-analysis block 112 is an example of a selected metadata receiver block, and acquires the metadata concerning the content for which the operation scheduling has been performed in the portable device 200. Then, in accordance with a content of the metadata, the data control section 110 reads the selected content from the storage area 102 and sends the content to the portable device 200, for example.

In addition, the data control section 110 is an example of a metadata generation section, and generates the metadata concerning the content stored in the storage area 102, and also generates the metadata concerning the content acquired from the external storage medium, for example.

The interface section 120 is connected to the portable device 200 to send the content and the metadata to the portable device 200. The interface section 120 sends and receives the data in accordance with the USB, IEEE 1394, IEEE802.11a/b/g, or Bluetooth system, for example. That is, the interface section 120 may send and receive the data either via a cable or in a wireless manner.

Next, the portable device 200 according to the present embodiment will now be described below. As shown in FIG. 1, the portable device 200 includes a storage area 202, a UI section 206, a data control section 210, a meta-generation block 212, and an interface section 220.

The storage area 202 is formed by an HDD, a flash memory, or the like, for example. Under control of the data control section 210, the storage area 202 is capable of data writing, data reading, data deletion, and so on. The data related to the music, movie, or other contents as received from the host device 100 are stored in the storage area 202. In addition, the metadata concerning the content is stored in the storage area 202. As noted previously, the metadata includes the information concerning the data operation scheduling. When the operation scheduling has been performed in the portable device 200, the information concerning the operation scheduling is written to an operation scheduling field in the metadata, for example.

For example, while the portable device 200 is not connected to the host device 100, a user may schedule (i.e., perform an operation scheduling for) the addition of a new content or the deletion of a content using the portable device 200. When this happens, information about the operation scheduling is recorded in the metadata. Then, when the portable device 200 has been connected to the host device 100 thereafter, the metadata is sent to the host device 100, and the scheduled operation is actually performed.

The UI section 206 functions as a user interface to accept an operation by the user of the portable device 200 and send data concerning the operation to the data control section 210. For example, the UI section 206 transfers the content from the external storage medium, and manages the contents stored in the storage area 202. In addition, the UI section 206 displays an operation being performed in the portable device 200, so that the user can recognize the operation being performed in the portable device 200. The UI section 206 is an example of a selection section, and when the storage area 202 stores the metadata but does not store the content corresponding to the metadata, the UI section 206 selects the metadata corresponding to the content that is not stored in the storage area 202 in accordance with a user operation.

The data control section 210 controls the exchange of the contents and the metadata with the host device 100, the generation and deletion of the data, the storage of the data in the storage area 202, and so on. The data control section 210 is an example of a content receiver section, and receives the content related to the selected metadata from the host device 100.

The data control section 210 includes the meta-generation block 212. The meta-generation block 212 determines, at the time of the operation scheduling, whether the operation scheduling is possible, and generates the metadata concerning the operation scheduling, or writes the information concerning the operation scheduling to the operation scheduling field in the metadata, for example. The meta-generation block 212 is an example of a selected metadata sender block, and when the metadata for the content that is not stored in the storage area 202 has been selected, the meta-generation block 212 sends the selected metadata to the host device 100.

The interface section 220 is connected to the host device 100 to send the content and the metadata to the host device 100.

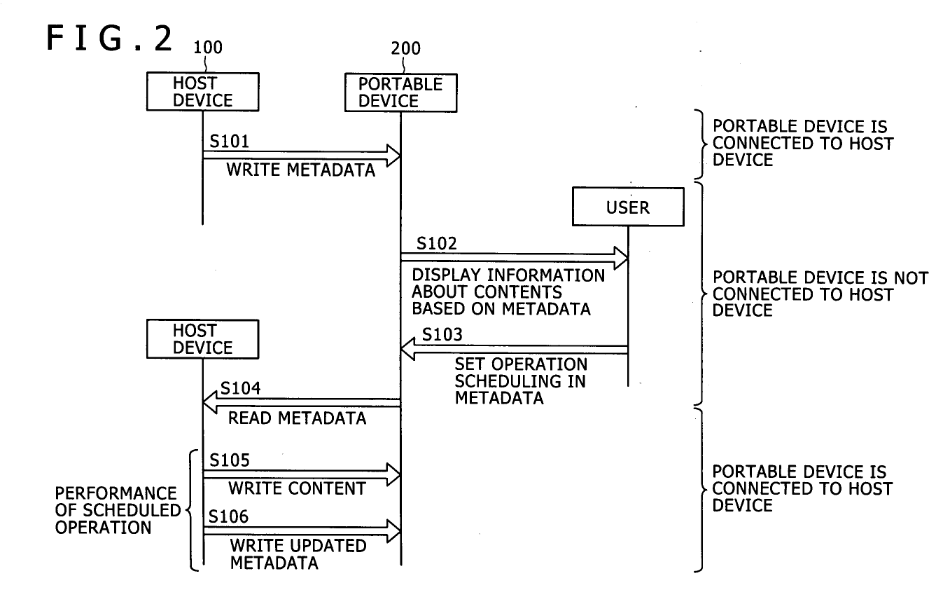

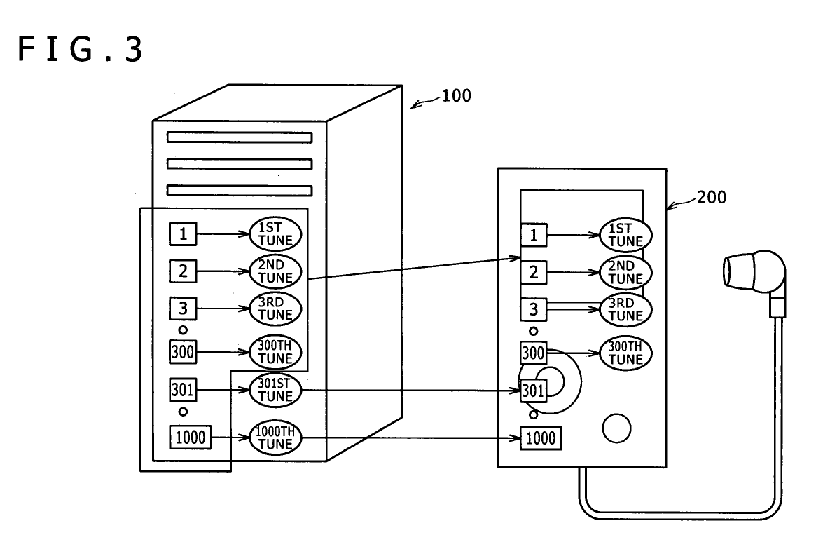

Next, an operation of the content sender/receiver system according to the present embodiment will now be described below. FIG. 2 is a flowchart illustrating the operation of the content sender/receiver system according to the present embodiment. FIG. 3 is a schematic diagram illustrating the operation of the content sender/receiver system according to the present embodiment.

In the present embodiment, the metadata concerning the content is generated in the host device 100, and the metadata is sent from the host device 100 to the portable device 200 (step S101). For example, in the case where a plurality of contents (i.e., 1st to 1000th tunes) are stored in the host device 100 as illustrated in FIG. 3, pieces of metadata (No. 1 to 1000) concerning the respective contents are generated in the host device 100, and the pieces of metadata No. 1 to 1000 are sent to the portable device 200. At this time, the host device 100 and the portable device 200 are connected to each other.

Next, when the portable device 200 is not connected to the host device 100 and is used singly, meta-information such as the titles of the contents is displayed via the UI section 206 of the portable device 200 as a result of a user operation (step S102). In the display of the meta-information presented at this time, the contents that are stored in the portable device 200 and the contents whose metadata is stored in the portable device 200 but which themselves are not stored in the portable device 200 are distinguished from each other. In the example as illustrated in FIG. 3, for example, the contents of the 1st to 300th tunes are stored in the portable device 200, while the contents related to the pieces of metadata No. 301 to 1000 are not stored in the portable device 200.

Then, for example, the user schedules an operation of receiving, from the host device 100, the content whose metadata is stored in the portable device 200 but which itself is not stored in the portable device 200 (step S103). In response to this scheduling, the meta-generation block 212 of the portable device 200 determines whether this operation scheduling is possible. In the case where the operation scheduling is possible, the meta-generation block 212 generates the metadata concerning the operation scheduling.

Next, when the portable device 200 and the host device 100 have been connected to each other again, the host device 100 reads the metadata from the portable device 200 (step S104). In the case where the operation scheduling related to sender of a content is recorded in the metadata, the host device 100 sends the content to the portable device 200 (step S105). As a result, the content for which the operation scheduling was performed when the portable device 200 was not connected to the host device 100 is stored in the portable device 200.

For example, suppose that in the example as illustrated in FIG. 3, the operation scheduling is performed with respect to the pieces of metadata No. 301 and No. 1000. In this case, when the portable device 200 and the host device 100 have been connected to each other, the contents of the 301st and 1000th tunes are sent from the host device 100 to the portable device 200.

Note that while the portable device 200 is not connected to the host device 100 and is used singly, the metadata in the host device 100 may be updated. Thus, when the portable device 200 and the host device 100 have been connected to each other, the metadata as updated may be sent to the portable device 200 (step S106), so that the updated metadata is stored in the portable device 200. Thus, when performing a next operation scheduling, the user is able to perform the operation scheduling based on the updated metadata.

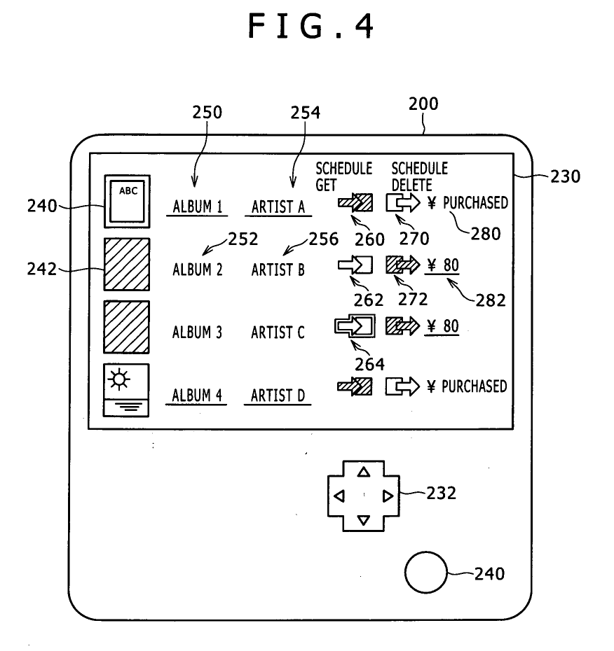

Next, an example of a display screen 230 of the portable device 200 according to the present embodiment will now be described below. FIG. 4 is a diagram illustrating the display screen of the portable device 200 according to the present embodiment.

On the display screen 230 of the portable device 200 are displayed, for example: icons 240 and 242 concerning the contents, titles 250 and 252, artists 254 and 256, icons 260, 262, 264, 270, and 272 concerning the operation scheduling, “purchased” icons 280, and prices 282.

For each of the contents that are stored in the portable device 200, the icon 240 concerning the content is displayed, and the title 250 and the artist 254 are displayed so as to be selectable. As to the icons concerning the operation scheduling, since the contents are stored in the portable device 200, the icon 260 for obtaining the content from the host device 100 is displayed so as not to be selectable but the icon 270 for deleting the content from the host device 100 is displayed so as to be selectable.

On the other hand, for each of the contents whose metadata is stored in the portable device 200 but which themselves are not stored in the portable device 200, the icon 242 concerning the content is not displayed, and the title 252 and the artist 256 are displayed so as not to be selectable. As to the icons concerning the operation scheduling, the icon 262 for obtaining the content from the host device 100 is displayed so as to be selectable, but the icon 272 for deleting the content from the host device 100 is displayed so as not to be selectable. The icon 264 is an icon that has been selected by the user to obtain the corresponding content from the host device 100.

User operations as mentioned above are performed using select buttons 232 and 240 provided on the portable device 200 or the like, for example.

### Second Embodiment

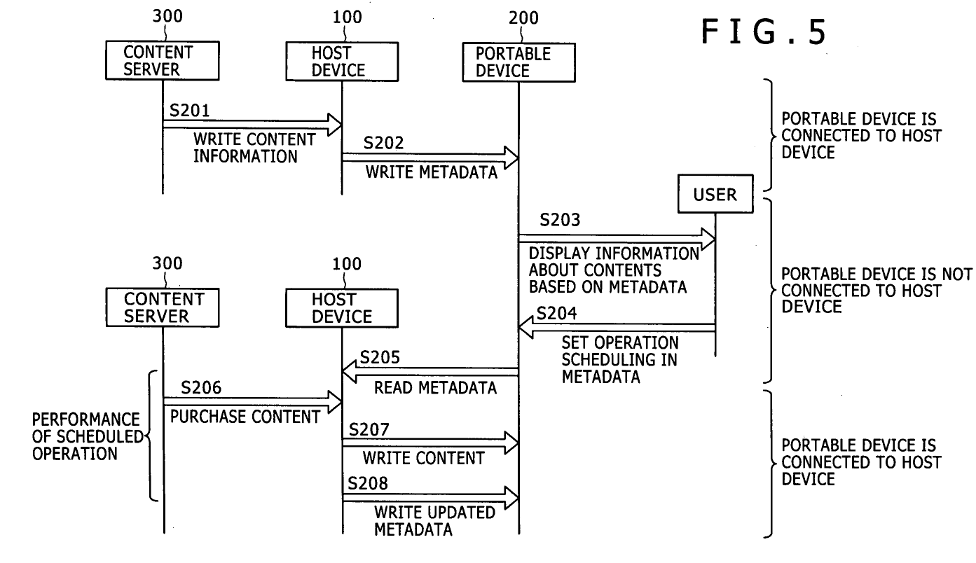

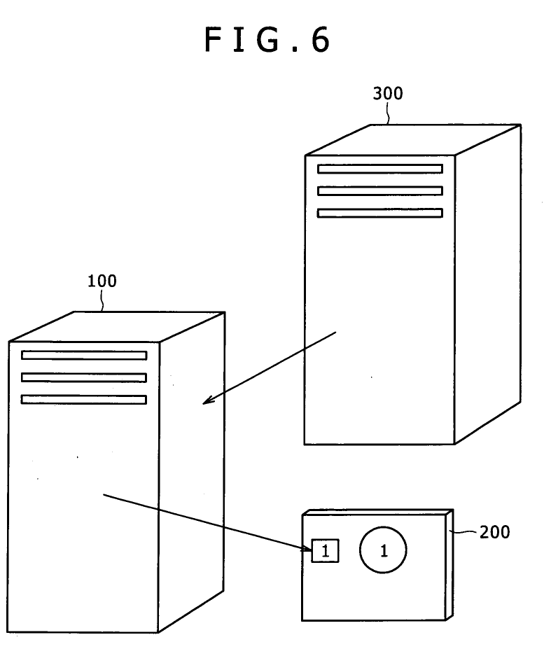

Next, a content sender/receiver system according to a second embodiment of the present invention will now be described below. FIG. 5 is a flowchart illustrating an operation of the content sender/receiver system according to the present embodiment. FIG. 6 is a schematic diagram illustrating the operation of the content sender/receiver system according to the present embodiment.

In the first embodiment, it has been assumed that the contents are primarily stored in the storage area 102 of the host device 100. On the other hand, in the present embodiment, the contents are acquired via a network.

The content sender/receiver system according to the present embodiment has substantially the same structure as that of the content sender/receiver system according to the first embodiment. Therefore, detailed description of the structure thereof is omitted. In the content sender/receiver system according to the present embodiment, a content server 300 and the host device 100 are connected to each other via the network. The content server 300 stores a plurality of contents, and in response to a request from the host device 100, the content server 300 delivers the contents to the host device 100.

The NIC 108 of the host device 100 is an example of a content information acquisition section, and acquires information concerning the content from the content server 300 via the network. The data control section 110 is an example of the metadata generation section, and generates the metadata based on the content information acquired by the NIC 108.

Next, the operation of the content sender/receiver system according to the present embodiment will now be described below. First, the information concerning the content is written from the content server 300 to the host device 100 (step S201). Then, the metadata concerning the content is generated in the host device 100, and the metadata is sent from the host device 100 to the portable device 200 (step S202). At this time, the host device 100 and the portable device 200 are connected to each other.

Next, while the portable device 200 is not connected to the host device 100 and is used singly, the meta-information such as the titles of the contents is displayed via the UI section 206 of the portable device 200 as a result of the user operation (step S203). In the display of the meta-information presented at this time, the contents that are stored in the portable device 200 and the contents whose metadata is stored in the portable device 200 but which themselves are not stored in the portable device 200 are distinguished from each other.

Then, for example, the user schedules an operation of receiving (i.e., obtaining), from the host device 100, the content whose metadata is stored in the portable device 200 but which itself is not stored in the portable device 200 (step S204). In response to this scheduling, the meta-generation block 212 of the portable device 200 determines whether this operation scheduling is possible. In the case where the operation scheduling is possible, the meta-generation block 212 generates the metadata concerning the operation scheduling.

Next, when the portable device 200 and the host device 100 have been connected to each other again, the host device 100 reads the metadata from the portable device 200 (step S205). In the case where the operation scheduling related to the sender of a content is recorded in the metadata, the host device 100 requests the content server 300 to deliver the content, thus purchasing the content (step S206). Then, the host device 100 sends the content to the portable device 200, so that the content is written to the portable device 200 (step S207). In this manner, the content for which the operation scheduling was performed when the portable device 200 was not connected to the host device 100 is obtained by the portable device 200.

Note that while the portable device 200 is not connected to the host device 100 and is used singly, the metadata in the host device 100 may be updated. Thus, when the portable device 200 and the host device 100 have been connected to each other, the metadata as updated may be sent to the portable device 200 (step S208), so that the updated metadata is stored in the portable device 200. Thus, when performing a next operation scheduling, the user is able to perform the operation scheduling based on the updated metadata.

While the preferred embodiments of the present invention have been described in detail above with reference to the accompanying drawings, the present invention is not limited to the above-described embodiments. It should be understood by those skilled in the art that various modifications, combinations, sub-combinations and alterations may occur depending on design requirements and other factors insofar as they are within the scope of the appended claims or the equivalents thereof.

For example, in the above-described embodiments, the case has been described where the metadata is generated in the host device 100 and, based on the metadata generated in the host device 100, the user of the portable device 200 schedules the acquisition of the content that is not stored in the portable device 200. Note, however, that the present invention is not limited to this exemplary case. For example, it may be so arranged that metadata concerning information such as the title and artist of a desired content is generated by the user operating the portable device 200, and that the metadata thus generated is sent to the host device 100. In this case, the host device 100 sends the content to the portable device 200 based on the metadata generated in the portable device 200. This allows the portable device 200 to acquire any content that the user desires to obtain when the portable device 200 is not connected to the host device 100, even if the metadata for that content has not been generated by the host device 100.

What is claimed is:

1. A server device configured to send a content to a terminal device when the server device and the terminal device are capable of connecting to each other, the server device comprising:
a selected metadata receiver section configured to, when metadata concerning the content that is not stored in the terminal device has been selected in the terminal device, receive the selected metadata; and
a content sender section configured to send the content related to the selected metadata to the terminal device.

2. The server device according to claim 1, further comprising:
a metadata generation section configured to generate the metadata concerning the content; and
a metadata sender section configured to send the generated metadata to the terminal device.

3. The server device according to claim 2, further comprising
a content information acquisition section configured to acquire content information concerning the content via a network, wherein
said metadata generation section generates the metadata based on the content information acquired by said content information acquisition section.

4. A terminal device configured to receive a content from a server device when the terminal device and the server device are capable of connecting to each other, the terminal device comprising:
a recording section configured to record the content and metadata concerning the content on a storage medium;
a selection section configured to select the metadata concerning the content that is not stored in the storage medium;
a selected metadata sender section configured to send the selected metadata to the server device; and
a content receiver section configured to receive the content related to the selected metadata from the server device.

5. The terminal device according to claim 4, wherein,
said selection section selects the metadata concerning the content that is not stored in the storage medium when the terminal device is not connected to the server device, and
said selected metadata sender section sends the selected metadata to the server device when the terminal device has been connected to the server device.

6. The terminal device according to claim 4, further comprising
a metadata receiver section configured to receive the metadata concerning the content from the server device.

7. The terminal device according to claim 4, further comprising
a metadata generation section configured to generate the metadata concerning the content.

8. A content sender/receiver system configured to send and receive a content when a server device and a terminal device are capable of connecting to each other, wherein,
the terminal device includes
a recording section configured to record the content and metadata concerning the content on a storage medium,
a selection section configured to select the metadata concerning the content that is not stored in the storage medium, and
a selected metadata sender section configured to send the selected metadata to the server device,
the server device includes
a selected metadata receiver section configured to receive the selected metadata, and
a content sender section configured to send the content related to the selected metadata to the terminal device, and
the terminal device further includes
a content receiver section configured to receive the content related to the selected metadata from the server device.

9. The content sender/receiver system according to claim 8, wherein,
the selection section selects the metadata concerning the content that is not stored in the storage medium when the terminal device is not connected to the server device, and
the selected metadata sender section sends the selected metadata to the server device when the terminal device has been connected to the server device.

10. The content sender/receiver system according to claim 8, wherein,
the server device further includes
a metadata generation section configured to generate the metadata concerning the content, and
a metadata sender section configured to send the generated metadata to the terminal device, and
the terminal device further includes
a metadata receiver section configured to receive the metadata from the server device.

11. The content sender/receiver system according to claim 10, wherein,
the server device is connected to a network, and further includes
a content information acquisition section configured to acquire content information concerning the content via the network, and
the metadata generation section generates the metadata concerning the content based on the content information acquired by the content information acquisition section.

12. The content sender/receiver system according to claim 8, wherein the terminal device further includes
a metadata generation section configured to generate the metadata concerning the content.

13. The content sender/receiver system according to claim 8, wherein the metadata includes at least one of
data concerning a location at which the content is stored and to which the content is to be sent and
data concerning whether or not the metadata has been selected by the selection section.

14. A content sender/receiver method for sending and receiving a content when a server device and a terminal device are capable of connecting to each other, the method comprising the steps of:
recording the content and metadata concerning the content on a storage medium in the terminal device;
in the terminal device, selecting the metadata concerning the content that is not stored in the storage medium when the server device and the terminal device are not connected to each other;
the terminal device sending the selected metadata to the server device;
the server device receiving the selected metadata from the terminal device;
the server device sending the content related to the selected metadata to the terminal device; and
the terminal device receiving the content related to the selected metadata from the server device.

15. A program to be executed by a computer in a server device configured to send a content to a terminal device when the server device and the terminal device are capable of connecting to each other, the program causing the computer to perform the steps of:
when metadata concerning the content that is not stored in the terminal device has been selected in the terminal device, receiving the selected metadata; and
sending the content related to the selected metadata to the terminal device.

16. A program to be executed by a computer in a terminal device configured to receive a content from a server device when the server device and the terminal device are capable of connecting to each other, the program causing the computer to perform the steps of:
recording the content and metadata concerning the content on a storage medium;
selecting the metadata concerning the content that is not stored in the storage medium;
sending the selected metadata to the server device; and
receiving the content related to the selected metadata from the server device.

17. A server device configured to send a content to a terminal device when the server device and the terminal device are capable of connecting to each other, the server device comprising:
selected metadata receiver means for, when metadata concerning the content that is not stored in the terminal device has been selected in the terminal device, receiving the selected metadata; and
content sender means for sending the content related to the selected metadata to the terminal device.

18. A terminal device configured to receive a content from a server device when the terminal device and the server device are capable of connecting to each other, the terminal device comprising:
recording means for recording the content and metadata concerning the content on a storage medium;
selection means for selecting the metadata concerning the content that is not stored in the storage medium;
selected metadata sender means for sending the selected metadata to the server device; and
content receiver means for receiving the content related to the selected metadata from the server device.
